(19) United States
(12) Patent Application Publication
(10) Pub. No.: US 2009/0025881 A1
(43) Pub. Date: Jan. 29, 2009

(54) APPARATUS FOR BINDING STACKS OF FLAT COMPONENTS

(75) Inventor: Peter Westermann, Berkel-Enschot (NL)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/243,062

(22) Filed: Oct. 1, 2008

Related U.S. Application Data
(63) Continuation of application No. PCT/EP2007/002997, filed on Apr. 3, 2007.

(30) Foreign Application Priority Data
Apr. 4, 2006 (DE) 202006005590.8

(51) Int. Cl. B29C 65/14; B29C 65/52

(52) U.S. Cl. 156/379.6

(57) ABSTRACT

An apparatus for binding stacks of flat components, in particular paper pads and books, having a binding agent applicator for applying liquid binding agent along a narrow side of the stack by moving the narrow side of the stack and the binding agent applicator relative to each other. The binding agent applicator has a slotted nozzle which extends at an angle, preferably a right angle, to the direction of the relative motion and is provided for dispensing binding agent that is curable by radiation. A radiation source for curing the binding agent is positioned adjacent to the binding agent applicator.

The present application is a continuation of PCT Application Serial No. PCT/EP2007/002997 filed Apr. 3, 2007 and claims priority under 35 U.S.C. § 119 of German Patent Application No. 202006005590.8 filed Apr. 4, 2006, the disclosures of which are hereby fully incorporated by reference herein.

### TECHNICAL FIELD

The invention relates to an apparatus for binding stacks of flat components, in particular paper pads and books, having a binding agent applicator for applying liquid binding agent along a narrow side of the stack by moving the narrow side of the stack and the binding agent applicator relative to each other.

### BACKGROUND

Apparatus of the type described above are in practical use in many forms, and are used in particular for binding books. It has been found, however, that the conventional apparatus do not operate with the precision demanded today, require a relatively large amount of binding agent, consume relatively large quantities of energy, are susceptible to dust and dirt and/or require a relatively large design or a relatively large amount of space. These disadvantages, which are enumerated only by way of example, also result in relatively high manufacturing, operating and servicing costs.

It is therefore an object of the present invention to improve an apparatus of the type named at the beginning so that the aforementioned disadvantages are substantially avoided.

### SUMMARY

The invention provides an apparatus for binding stacks of flat components, in particular paper pads and books, having a binding agent applicator for applying liquid binding agent along a narrow side of the stack by moving the narrow side of the stack and the binding agent applicator relative to each other. More particularly, the binding agent applicator has a slotted nozzle which extends at an angle, preferably at a right angle, to the direction of relative movement and is provided for dispensing binding agent which may be cured by radiation. A radiation source for curing the binding agent is positioned adjacent to the binding agent applicator.

The invention therefore includes the use of a slotted nozzle for dispensing binding agent that is curable by radiation in combination with the adjacent positioning of a radiation source for curing this binding agent. The use of a slotted nozzle, which is already known per se (for example from DE 195 18 604 A1 and corresponding U.S. Pat. No. 5,862,993 A), enables specific metered dispensing and precisely controlled application essentially over the entire width of the narrow side of the stack that is to be bound, so that more binding agent than necessary is not used. However, the low usage of binding agents that may be realized with the invention also results from the fact that the slotted nozzle is usually part of a so-called closed system. Furthermore, the use of a slotted nozzle in a closed system is less susceptible to dust and dirt, which is of great importance in the application under consideration here, since the narrow side of the stack being bound is usually prepared appropriately directly before binding using cutting tools and/or by milling or by some other cutting process. Because of the adjacent positioning of the radiation source, the area of application of the binding agent on the narrow side of the stack or the spine of the book can be irradiated selectively and thus with the desired intensity, which makes it possible to achieve focused and thus rapid curing of the applied binding agent.

For all of these reasons, the design according to the invention not only results in higher quality and thriftier energy usage, but also in a space-saving design of the entire apparatus. Finally, the design according to the invention, which incidentally can also be retrofitted on any conventional binding apparatus, enables both the manufacturing costs and the operating and servicing costs to be lowered.

Preferably, the binding agent is curable by ultraviolet light radiation, and accordingly the radiation source is a UV light radiation source. Polyurethane is suitable for this purpose.

In another embodiment of the invention, the radiation source is located at a fixed position relative to the binding agent applicator. Because of such fixed relative positioning, the desired irradiation of the binding agent area on the narrow side of the stack can be realized with especially high precision. In the event that an appropriate mounting support is provided for attaching the binding agent applicator, the radiation source should also be attached to that support; this makes the desired fixed relative positioning possible in an especially simple manner. If a housing is provided that essentially accommodates the binding agent applicator, the radiation source should also be essentially situated on and/or in such a housing, in order to achieve the desired fixed relative positioning in an especially simple manner.

If a cooling device is needed to cool the radiation source, a water cooling device should preferably be used for that purpose. In contrast to a conventional air cooling system, application of the binding agent remains completely unaffected by a water cooling system. Furthermore, a water cooling system does not result in any formation of dust or soiling, so that it requires no exhaust air filters or the like and hence is nearly maintenance-free. Finally, the radiation source can be cooled especially precisely with a water cooling system and complies with the demand for a space-saving design of the entire apparatus.

Preferably, an optical diaphragm may be provided that can be moved into the beam path of the beam produced by the radiation source, making it possible to interrupt the light beam and thus the effect of the radiation source almost without delay. This cannot be achieved in such a short time with normal on-and-off switching of the radiation source, since in particular when the radiation source is switched on it requires a certain time before it develops its full effect. Furthermore, frequent switching on and off results in increased wear on the radiation source. Hence this embodiment contributes to increased processing speed.

In another embodiment, a holding device for holding the stack is designed so that the stack is positionable with its narrow side which is to be bound essentially above the binding agent applicator.

Furthermore, the radiation source may optionally be situated and designed so that the beam which it produces is directed upward.

Preferably, the radiation source is adjustable in relation to the narrow side in terms of position, distance and angle.

Expediently, the binding agent applicator and the radiation source are stationary, and a holding device for holding the stack is situated so that it is movable, in order to guide the narrow side of the stack past the binding agent applicator and the radiation source.

It should also be noted that the apparatus according to the invention is not intended only for using binding agent for joining the flat components of a stack with each other along one of its narrow sides, i.e., for example for joining the pages of a book along the spine of the book, but can also optionally be provided so that the binding agent may be applied to the narrow side of the stack or to the spine of the book in such a way that it may also be used for attaching an essentially flat covering element such as the spine cover of a book.

### BRIEF DESCRIPTION OF THE DRAWINGS

A preferred but exemplary embodiment of the invention will be explained in greater detail below on the basis of the attached drawings.

FIG. 1 is a schematic top view of an apparatus for binding book blocks according to a preferred embodiment of the invention, having a binding agent applicator and a radiation source; to better illustrate the individual working steps a first book block is shown before entry into the apparatus, a second book block at the binding agent applicator, a third book block at the radiation source and a fourth book block after emerging from the apparatus; and

FIG. 2 is a schematic side view of the arrangement of FIG. 1.

### DETAILED DESCRIPTION

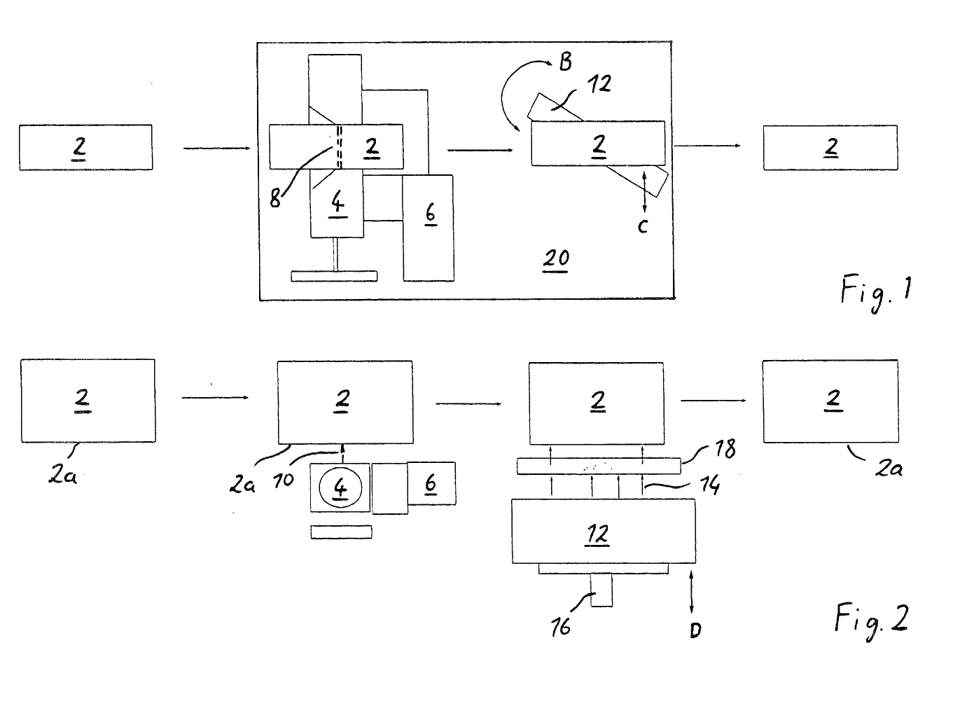

The apparatus depicted in FIGS. 1 and 2 serves primarily for binding book blocks 2, but may also be used for binding paper pads, or quite generally stacks of almost any flat components.

The depicted apparatus has a binding agent applicator 4, which is connected to a reservoir 6 containing liquid binding agent. Binding agent applicator 4 has a slotted nozzle 8, which is depicted only by dashed lines in FIG. 1, and which together with reservoir 6 is part of a closed system that is provided in binding agent applicator 4. The binding agent used in the depicted exemplary embodiment is liquid polyurethane, which is stored in reservoir 6 and dispensed through the aforementioned slotted nozzle. The binding agent is depicted schematically in FIG. 2 only as a directed spray 14 emitted from the slotted nozzle 8 (FIG. 1) in the form of a dashed line.

Situated adjacent to binding agent applicator 4, in a fixed position relative to it, is a light beam source 12 for producing ultraviolet radiation 14. The ultraviolet light radiation 14 produced by the beam source 12 serves to cure the binding agent applied to the book spine 2a by binding agent applicator 4. For cooling, UV light beam source 12 contains a water cooling device, of which only an external connection 16 is depicted recognizably in FIG. 2. Mounted on the front side at a distance from radiation source 12 is an optical diaphragm 18, which is movable into the beam path of the ultraviolet light radiation 14 in order to darken the radiation source 12 when necessary.

Binding agent applicator 4 and radiation source 12 are jointly supported and attached to a mounting support 20, which can be seen only in FIG. 1 and is depicted there schematically as a rectangular base. Additionally or alternatively, it is also conceivable to situate binding agent applicator 4 and radiation source 12 in a housing, where optionally radiation source 12 may be attached not in but on such a housing.

Binding agent applicator 4 and radiation source 12 are not only situated in an adjacent fixed position relative to each other, but in the illustrated exemplary embodiment are also stationary, while the book block that is being bound is moved past binding agent applicator 4 and then past radiation source 12, as can be seen schematically in FIGS. 1 and 2. FIGS. 1 and 2 show book block 2 in four different working positions: from left to right in a first position before entry into the apparatus, in a second position at binding agent applicator 4, in a third position at radiation source 12 and in a fourth position after leaving the apparatus.

As FIGS. 1 and 2 also show, book block 2 is moved in the direction of arrow A along a transport path which is part of a process line of a facility (not shown). Before entry into the described apparatus, the book block is produced from loose sheets and appropriately oriented in up-line devices that are not depicted in the figures. Furthermore, the book spine which is to be bound is produced for example by cutting or milling.

For the transport of book block 2 shown schematically in FIGS. 1 and 2, a mounting support (not shown) is provided which not only holds book block 2, preferably with the help of flat clamping elements 2, but also moves it along the transport path through the apparatus in the direction of arrow A. In the depicted exemplary embodiment, that mounting support is situated and designed in such a way that the book block 2 is moved past with its spine 2a which is to be bound above binding agent applicator 4 and radiation source 12, as can be seen in particular in FIG. 2. Thus binding agent applicator 4 is designed so that it dispenses the binding agent upward in the direction of the book spine 2a which is above it. Slotted nozzle 8 extends at an angle, preferably at a right angle to the direction of motion according to arrow A, and preferably across the entire width of book spine 2a. For effective and focused application of the binding agent, the distance between slotted nozzle 8 and book spine 2a should be relatively small.

After leaving binding agent applicator 4, the book spine 2a provided with the binding agent is irradiated by the ultraviolet light radiation 14 produced by radiation source 12. To this end, optical diaphragm 18 must release the beam path of the light radiation 14, so that the latter reaches the book spine 2a. Since in the depicted exemplary embodiment book block 2 is also guided with its spine 2a which is to be bound above radiation source 12, as can be seen in particular from FIG. 2, radiation source 12 must likewise be situated and designed so that the light radiation 14 which it produces is directed upward onto the spine 2a of book block 2. Depending on the curing properties of the binding agent, optical diaphragm 18 releases the light radiation 14 for a certain period of time before book block 2 then leaves the radiation source 12 and hence the apparatus. Optical diaphragm 18, which is movable into the beam path of the light radiation 14, serves not only to control the curing process, but in the event that production is interrupted it also serves to prevent the escape of then unwanted ultraviolet light radiation.

As shown schematically in FIGS. 1 and 2 on the basis of the double arrows B, C and D, radiation source 12 is adjustable with regard to position, distance and angle relative to the spine 2a of book block 2. This adjustment may optionally be done manually or automatically by a drive device (not shown).

During production, the energy required for the radiation source 12 may be appropriately adapted automatically to different processing speeds und different properties of various substrates employed. To this end, a control device not depicted in the figures may be provided, which also appropriately controls the delivery of the binding agent by binding agent applicator 4. What is claimed is:

1-12. (canceled)

13. An apparatus for binding stacks of flat components, comprising:
an applicator configured to apply a liquid, radiation-curable binding agent, said applicator adapted to apply the binding agent along a narrow side of a stack and mounted for relative movement with respect to the narrow side of the stack, said applicator including a slotted nozzle extending at an angle relative to the direction of relative movement; and
a radiation source positioned adjacent said applicator for curing the binding agent.

14. The apparatus of claim 13, wherein said slotted nozzle extends at a right angle relative to the direction of relative movement.

15. The apparatus of claim 13, wherein, said radiation source includes an ultraviolet light for curing the binding agent.

16. The apparatus of claim 13, wherein said applicator is configured to dispense polyurethane.

17. The apparatus of claim 13, wherein said radiation source is in a fixed position relative to said applicator.

18. The apparatus of claim 13, further comprising:
a mounting support coupling said applicator and said radiation source.

19. The apparatus of claim 13, further comprising:
a housing holding said applicator and said radiation source.

20. The apparatus of claim 13, further comprising:
a cooling device for cooling said radiation source.

21. The apparatus of claim 20, wherein said cooling device includes a water cooling device.

22. The apparatus of claim 13, wherein said radiation source is configured to produce a beam of radiation, said apparatus further comprising an optical diaphragm movable into a path of the beam.

23. The apparatus of claim 13, further comprising:
a holding device for holding the stack, said holding device configured to hold the stack such that the narrow side thereof is substantially above said applicator.

24. The apparatus of claim 13, wherein said radiation source is positioned to produce an upward-directed beam of radiation.

25. The apparatus of claim 13, wherein said radiation source is adjustable in position, distance, and angle relative to the narrow side of the stack.

26. The apparatus of claim 13, wherein said applicator and said radiation source are stationary relative to one another, said apparatus further comprising a holding device for holding the stack and movable to guide the narrow side of the stack past said applicator and said radiation source.
